(19) United States
(12) Patent Application Publication
(10) Pub. No.: US 2019/0122320 A1
(43) Pub. Date: Apr. 25, 2019

(54) Internet of Dogs' Identifiers System and Method of Operation for Trained Assistance Animal Status and Verification

(71) Applicants: PAUL EUGENE MUNDELL, Santa Rosa, CA (US); Jacquelyn Ruth Antonini, Santa Rosa, CA (US)

(72) Inventors: PAUL EUGENE MUNDELL, Santa Rosa, CA (US); Jacquelyn Ruth Antonini, Santa Rosa, CA (US)

(21) Appl. No.: 15/788,774

(22) Filed: Oct. 19, 2017

(51) Int. Cl. G06Q 50/26; G06Q 10/10; G06K 19/077; H04L 29/06

(52) U.S. Cl. CPC G06Q 50/26; G06Q 10/1093; H04L 67/12; H04L 63/0428; G06K 19/07758

(57) ABSTRACT

Identifying trained assistance animals expected at a gateway or accommodation by using wireless communications. It includes operating a trained assistance animal identity center, an active animal garment, and a wireless mobile communication device which variously download a plurality of protected ID files (portfolio) containing identity documentation of registered trained assistance animals expected at a location during a period of time; initiate a verification process by an active controlled garment that is worn by a microchipped trained assistance animal; return an encrypted Identity reference string; either request identity documentation from a service center database or match with a member of the portfolio; display the identity documentation (images, names, descriptions, trained behaviors, audio); or record the verification of a trained assistance animal at a time and place. Subscriber reservation systems access the service center to initiate a download of expected ID files. Trained assistance animal trainers provide identity documentation for graduates.

### CROSS-REFERENCES TO RELATED APPLICATIONS

None.

### STATEMENT REGARDING FEDERALLY SPONSORED RESEARCH OR DEVELOPMENT

Not Applicable

THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Technical Field

The present invention relates to verification of service animal training and status by wireless communication of animal identification indicia.

### Description of the Related Art

As is known, Charles Walton received U.S. Pat. No. 3,752,960 for an Electronic identification and recognition system on Aug. 14, 1973.

As is known, Radio-frequency identification (RFID) uses electromagnetic fields to automatically identify and track tags attached to objects. The tags contain electronically stored information. Passive tags collect energy from a nearby RFID reader's interrogating radio waves. Unlike a barcode, the tag need not be within the line of sight of the reader, so it may be embedded in the tracked object.

RFID tags are used in many industries, for example, implanting RFID microchips in livestock and pets allows for positive identification of animals.

In principle, every country can set its own rules for frequency allocation for RFID tags, and not all radio bands are available in all countries. These frequencies are known as the ISM bands (Industrial Scientific and Medical bands). The return signal of the tag may still cause interference for other radio users.

Low-frequency (LF: 125-134.2 kHz and 140-148.5 kHz) (LowFID) tags and high-frequency (HF: 13.56 MHz) (HighFID) tags can be used globally without a license.

Standards that have been made regarding RFID include: ISO 11784/11785—Animal identification. Uses 134.2 Khz.

A microchip implant is an identifying integrated circuit placed under the skin of an animal. The chip, about the size of a large grain of rice, uses passive RFID (Radio Frequency Identification) technology, and is also known as a PIT (Passive Integrated Transponder) tag.

A microchip implant is a passive RFID device. Lacking an internal power source, it remains inert until it is powered by the scanner.

Most implants contain three elements: a ‘chip’ or integrated circuit; a coil inductor, possibly with a ferrite core; and a capacitor. The chip contains unique identification data and electronic circuits to encode that information. The coil acts as the secondary winding of a transformer, receiving power inductively coupled to it from the scanner. The coil and capacitor together form a resonant LC circuit tuned to the frequency of the scanner's oscillating magnetic field to produce power for the chip. The chip then transmits its data back through the coil to the scanner.

These components are encased in biocompatible soda lime or borosilicate glass and hermetically sealed. Barring rare complications, dogs and cats are unaffected by them.

In most countries, pet ID chips adhere to an international standard to promote compatibility between chips and scanners.

The ISO Conformant Full Duplex type has the greatest international acceptance. It is common in many countries including Europe (since the late 1990s), U.S., and Canada. It is one of two chip protocol types that conform to International Organization for Standardization standards ISO 11784 & 11785. To support international/multivendor application, the 3-digit country code can contain an assigned ISO country code or a manufacturer code from 900 to 998 plus its identifying serial number.

As is known, the Americans with Disabilities Act provides that no documentation is required for service dogs. As is known, the Air Carrier Access Act provides that a letter from a medical health professional may be required for documentation of emotional support animals. As is known, some states are considering penalties for fraud in misrepresenting a pet as a service dog. As is known, the Transportation Safety Administration has improved the convenience of passengers boarding airplanes by utilizing Global Entry, Clear, and Known Traveler Numbers for TSA pre-check. Customer satisfaction and perceived fairness may be improved with an analogous treatment for emotional support and trained service assistance animals.

What is needed is a way to increase the convenience for individuals with disabilities in assuring that an animal which accompanies them meets the definition of a service or emotional support animal and is credibly distinguished from a pet.

### SUMMARY OF THE INVENTION

Persons with disabilities more conveniently reserve and access public accommodations and common carriers when identification documents are quickly matched for their trained assistance animal at a gateway or location using one or more wireless communication channels.

A system manages and distributes encrypted identifiers of registered service dogs and supporting information stored by their training authority or provenance provider.

Public accommodation providers and commercial air carriers may check for and utilize the identifiers when making travel, dining, or room reservations and admitting registered service dogs into their premises, facilities, and vehicles.

A wireless communication device configured with an authenticated application intermediates between an active cape/vest worn by a registered dog and the service provider of encrypted identifiers and supporting information.

An active cape/vest enables and monitors an injectable identity device provisioned to the registered service dog by its training authority.

The hashing or encryption and comparison of encrypted identifiers is performed by one of the cape/vest, the wireless communication device, or the service provider data center.

Upon matching, the wireless communication device displays message, images, or emits sounds further confirming the identity. The wireless communication device may further actuate a portal.

A system for identifying trained service animals expected at a gateway or accommodation by using wireless communications. It includes operating a service animal identity center, an active animal garment, and a wireless mobile communication device which variously download a plurality of protected ID files (portfolio) containing identity documentation of registered service animals expected at a location during a period of time; initiate a verification process by an active controlled garment that is worn by a microchipped service animal; return an encrypted Identity reference string; either request identity documentation from a service center database or match with a member of the portfolio; display the identity documentation (images, names, descriptions, trained behaviors, audio); or record the verification of a trained service animal at a time and place. Subscriber reservation systems access the service center to initiate a download of expected ID files. Service animal trainers provide identity documentation for graduates.

At least one set of identification documents is distributed to a wireless communication device according to a scheduled access by a person accompanied by a trained assistance animal.

An active garment interrogates and transforms an identity code from a microchip injected in the trained assistance animal.

The wireless communication device opens and displays the identification document for the matching identity code.

### BRIEF DESCRIPTION OF THE SEVERAL VIEWS OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a non-limiting exemplary processor 100 for performance of processes and method steps of the invention when controlled by executable instructions encoded on non-transitory computer-readable media.

FIG. 2 illustrates a system 200 embodiment comprising the following apparatuses FIGS. 4, 6, 8 in mutual communication and performing the methods disclosed in FIGS. 3, 5, 7, 9.

FIG. 3 is a flowchart of processes and method steps for a system.

FIG. 4 is block diagram of a communication device 400 for use by an operator such as a gate agent or restaurant hostess greeting a person with disability who is accompanied by a trained assistance animal.

FIG. 5 is a method/process flow chart 500 of methods and processes performed by a processor at a communication device 400.

FIG. 6 is a block diagram of electronic components of a garment to be worn on a trained assistance animal which has been injected with a microchip for identification.

FIG. 7 is a method/process flow chart of methods and processes 700 performed by a processor at a garment 600.

FIG. 8 is a block diagram of a service center 800.

FIG. 9 is a method/process flow chart of methods and processes performed by a processor at a service center 800.

### DETAILED DISCLOSURE OF EMBODIMENTS OF THE INVENTION

The invention enables a wireless communication instrument or device to verify identity of a trained assistance animal which has been injected with an identity microchip. The success or failure of the verification can be indicated on either or both a garment worn by the trained assistance animal and the communication device. The communication device receives a subset of identity documentation stored into a server by a credentialing agency such as a federation or association of training programs.

Additionally, providers of public transportation or public services may link their reservation systems to download identity documentation to a location or venue and schedule seamless access for people partnered with trained assistance animals.

As can be appreciated, the invention can be perceived as a distributed system of interacting subsystems but performance of each subsystem is independently an embodiment of a separate invention described as follows:

A method of operation at a wireless mobile communication device performs the processes: receiving a plurality of protected ID files (portfolio) containing identity documentation of registered trained assistance animals expected within a period of time at a portal; initiating a verification process by an activated controlled garment (idcape) that is worn by a microchipped trained assistance animal; receiving at least one of an encrypted identity string and a garment serial number from said idcape (refhash); comparing said refhash with said portfolio; upon failing to match said refhash with a member of the portfolio, initiating a request for identity documentation (RID) process with a service center database and displaying a result of the RID; upon determining a successful refhash match with a member of the portfolio, opening one of the ID files and displaying the identity documentation (images, names, descriptions, trained behaviors, audio); and presenting an interactive display to confirm and record the successful verification of the trained assistance animal at a time and place.

In an embodiment, a trained assistance animal verification system may include some of but is not limited to: an activated controlled garment (idcape); the idcape communicatively coupled to, a wireless mobile communication device; said device communicatively coupled to, and a trained assistance animal identity service center host. Non-limiting exemplary wireless communication devices include optical scanners, magnetic scanners, radio transmitters and receivers of specific protocols and frequency bands such as Near Field Communications, Radio Frequency ID, Wi-Fi, cellular bands, Bluetooth, and infrared.

In an embodiment, the system also may include: at least one identity microchip injected into a trained assistance animal by a training provider; and an interface to at least one public accommodation reservation application server.

One independently operable aspect of the invention is a wireless communication device which provides: a transceiver communicatively coupled to exchange indices and identification documents with a trained assistance animal identity service host; a circuit to enable a controlled garment to cause an identification device embedded within a trained assistance animal to present it unique identity code; a circuit to receive and transform a unique identity code from the identification device; and a circuit to compare and subsequently annunciate the result of the comparison of unique identity codes received from a host and from a garment, which functionality may be performed by instructions encoded into non-transitory storage of a mobile wireless communication device and executed by processor of the device.

In an embodiment, such a wireless communication device may also include in an embodiment, a store for identity documents downloaded from a service center of trained assistance animals scheduled for admittance at a venue. That is, the device operates as a subsidiary service center upon receiving a subset of the documents primarily stored at the service center with respect to the trained assistance animals scheduled to be greeted and verified at the venue or venues pertinent to the location and role of the wireless communication device.

In an embodiment, the wireless communication device may also include a graphical display suitable for a photographic image of the trained assistance animal and its accompaniant.

In an embodiment, the wireless communication device may also include a circuit to enable the controlled garment to annunciate a successful comparison. In another embodiment, a wireless communication device comprises: a transceiver communicatively coupled to exchange indices and identification documents with a trained assistance animal identity service host; a circuit to cause an identification device embedded within a trained assistance animal to present it unique identity code; an energizing element for an injected identity microchip; a short range radio receiver for receiving an identity code; a circuit to transform a unique identity code from the identification device; a circuit to compare and subsequently annunciate the result of the comparison of unique identity codes received from a host and from a garment; a store for identity documents downloaded from a service center of trained assistance animals scheduled for admittance at a venue; and a graphical display suitable for a photographic image of the trained assistance animal and its accompaniant.

Another independently operable aspect of the overall invention is an activated controlled garment which may include some of but is not limited to: an energizing element for an injected identity microchip; a short-range radio receiver for identity code; an encoder to transform said identity code; a transceiver to exchange data with a wireless communication device, and an indicator circuit capable of emitting indicia of success or failure in validation.

Another aspect of the invention is an independently operable service center host which by performing executable instructions stored in non-transitory media enables and provisions: a trained assistance animal registration server accessible to trainers; a calendar server accessible to venue managers; a calendar server accessible to trained assistance animal handlers; a cross-reference mapping between venues and trained assistance animal identities; a computer-readable non-transitory store of trained assistance animal documents; and an interface to communication devices operable to read trained assistance animal garments and report success or failure on verifying a document. In an embodiment, when a wireless communication device has only one of a garment serial number and a code scanned from a microchip, the service center host downloads documentation associated with the animal assigned to the garment or the animal associated with the encrypted identity string.

Another aspect of the invention is a method, operating over distributed subsystem apparatuses, which may, in intermittent communication, perform the processes: comparing hash of eligible animals in database with hash received from vest; at a vest, enabling a microchip to emit a registration code; receiving a registration code from a microchip; transforming said registration code to a hashed code; requesting verification of code from server by cellular network transceiver; establishing secure upload with a communication device; verifying code with server provided documentation; at a communication device, determining that record of animal is one of found or not found 108; at a server, determining that record of animal is one of found or not found; upon the condition not found, activating indicia circuit to signal failure; upon the condition found, activating indicia circuit to signal the condition of trained assistance animal verified e.g. Sounding tone in vent.

In an embodiment of another aspect of the invention, a method of operating an activated controlled garment includes some of but not limited to the processes: receiving an initiation signal to energize at least one wireless transceiver; enabling an identification device embedded within a trained assistance animal to present its unique identity code; receiving said unique identity code associated with the trained assistance animal; and transforming said unique identity code for presentation to a wireless communication device.

In an embodiment, a method also includes: receiving indicia of acceptance of the unique identity code by the wireless communication device; and enabling feedback of the successful identification by actuators and a tangible interface device. This includes lights, sounds, or displays, which may be tangible to the trained assistance animal or to the observer/gate agent/hostess. The trained assistance animal may be trained to a certain behavior upon sensing the indicia of acceptance. The garment may change color or display an image or text.

Another aspect of the invention is a method of operating a trained assistance animal identity service center by performing the processes including but not limited to: receiving from a training entity identification documents for a trained assistance animal; registering a trained assistance animal into a known trained assistance animal store; receiving an encrypted index from a wireless communication device; retrieving identification documents by the encrypted index; and confirming the registration of the trained assistance animal by transmitting to the wireless communication device at least one identification document.

In an embodiment, the processes may also include: receiving from a reservation system a scheduled admittance for a trained assistance animal at a venue; verifying the registration of the trained assistance animal in an identifier data store; and distributing to a wireless communication device identification documents of at least one trained assistance animal scheduled for admittance at the venue. The distribution of identification documents can be on demand or by scheduled downloading. The downloading of documents can occur in response to arrival at the venue by the trained assistance animal or prior to a window of time during which the trained assistance animal is expected. Advantageously, downloading according to reservations would minimize stress on the service during peak travel or dining times.

In an embodiment, the process may also include additional steps of operating an actuator to enable a portal, and triggering an image capture device of any animal transiting the portal. In other words, the garment worn by a service dog, would enable entry or exit through a portal such as a door, which at the same time takes of photograph of exit or entry. This is an improvement in security over having possession of an inanimate key/magnetic stripe/RFID card.

Referring now to the figures, the invention is disclosed by non-limiting exemplary embodiments:

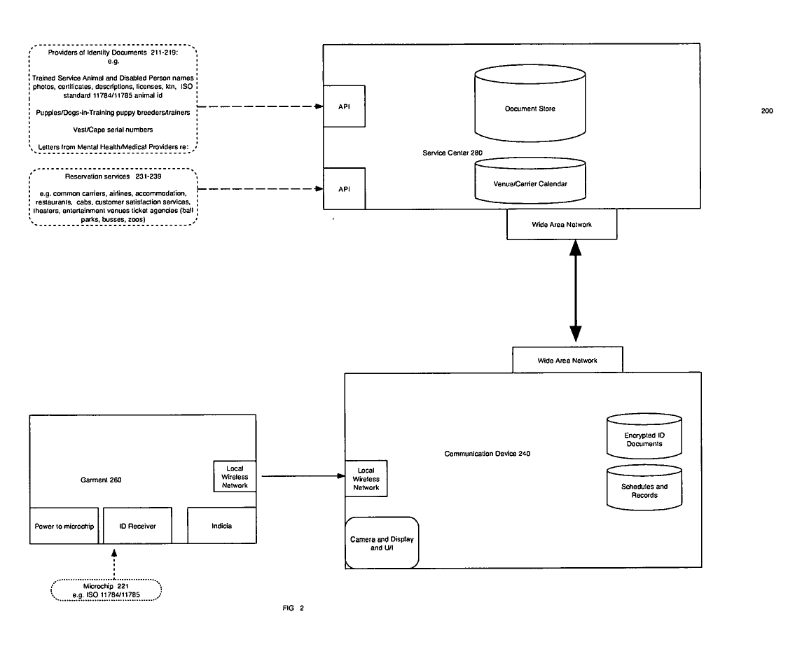

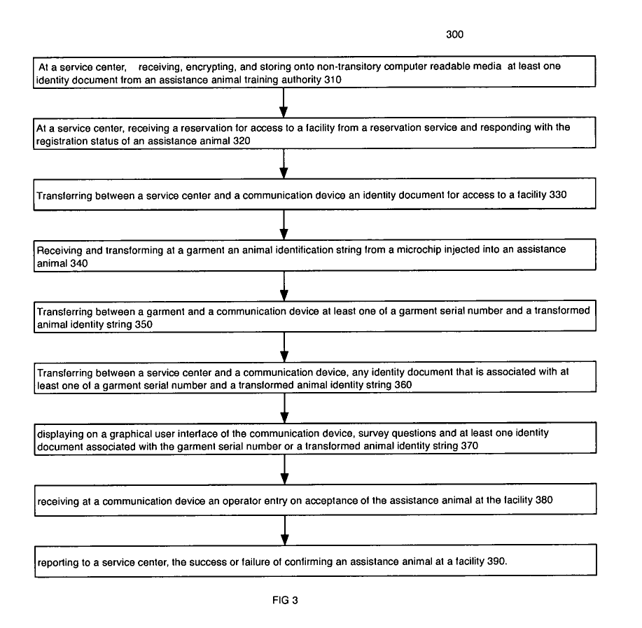

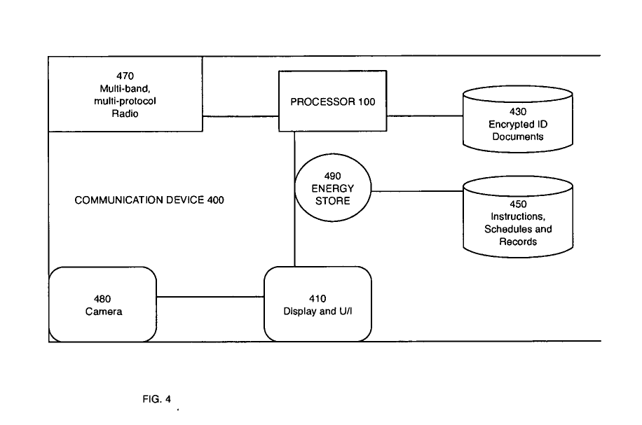

FIG. 2 illustrates a system 200 embodiment comprising the following apparatuses FIGS. 4, 6, 8 in mutual communication and performing the methods disclosed in FIGS. 3, 5, 7, 9.

FIG. 2 illustrates a system embodiment of the invention 200 which comprises a communication device 240; communicatively coupled to a garment 260; the communication device 240 further communicatively coupled to a service center 280.

In an embodiment, the service center 280 is further communicatively coupled by an Application Programming Interface 210 to at least one 211-219 provider of identity documents for trained assistance animals.

In an embodiment, the service center 280 is further communicatively coupled by an Application Programming Interface 230 to at least one 231-239 reservation service for common carriers, accommodations, restaurants, cabs, theaters, ticket agencies, and public venues.

In an embodiment, the garment 260 is further communicatively coupled by an electromagnetic signal to a microchip 221 injected into a trained service animal. In an embodiment of the invention the garment provides an RFID scanner such as standardized by ISO11784/11785.

In an embodiment, the garment 260 displays a QR code which is a transformation of the identity string assigned to the trained service animal or a serial number associated with the garment, or a combination thereof.

In an embodiment, the communication device receives a QR code by a camera. In an embodiment, the communication device supports a short-range radio network to receive an electromagnetic signal from the garment. In an embodiment, the communication device controls the operation of the garment by a short-range radio signal. An exemplary short range radio is Bluetooth, or RFID, or NFC.

In an embodiment, the communication device uses a wireless network to receive identity documents from the service center, request identity documents related to a garment or a trained service animal, and report success or failure of identification and resolution of the access request. In an embodiment, wireless network is by cellular radio. In an embodiment, wireless network is by 802.11 or 802.15 standards.

In an embodiment, the communication device uses a wide area network such as the Internet, Satellite Communications, Cable, or POTS to connect to the service center.

FIG. 3 is a flowchart of processes and method steps for a system.

A method 300 for operation of a system 200 comprising the processes: at a service center, receiving, encrypting, and storing onto non-transitory computer readable media at least one identity document from an assistance animal training authority 310; at a service center, receiving a reservation for access to a facility from a reservation service and responding with the registration status of an assistance animal 320; transferring between a service center and a communication device an identity document for access to a facility 330; receiving and transforming at a garment an animal identification string from a microchip injected into an assistance animal 340; transferring between a garment and a communication device at least one of a garment serial number and a transformed animal identity string 350; transferring between a service center and a communication device, any identity document that is associated with at least one of a garment serial number and a transformed animal identity string 360; displaying on a graphical user interface of the communication device, survey questions and at least one identity document associated with the garment serial number or a transformed animal identity string 370; receiving at a communication device an operator entry on acceptance of the assistance animal at the facility 380; and, 390 reporting to a service center, the success or failure of confirming an assistance animal at a facility.

FIG. 4 is block diagram of a communication device 400 for use by an operator such as a gate agent or restaurant hostess greeting a person with disability who is accompanied by a trained assistance animal, which device comprises: a processor 100, a display with user interface 410; a first non-transitory computer readable store 430 for encrypted identity documents; a second non-transitory computer readable store 450 for instructions, schedules and recordation of access; a multi-band multiprotocol radio 470 for communication to a garment and to a service center; and all said components and circuits coupled to an energy store device 490. In an embodiment, the apparatus further comprises a camera 480.

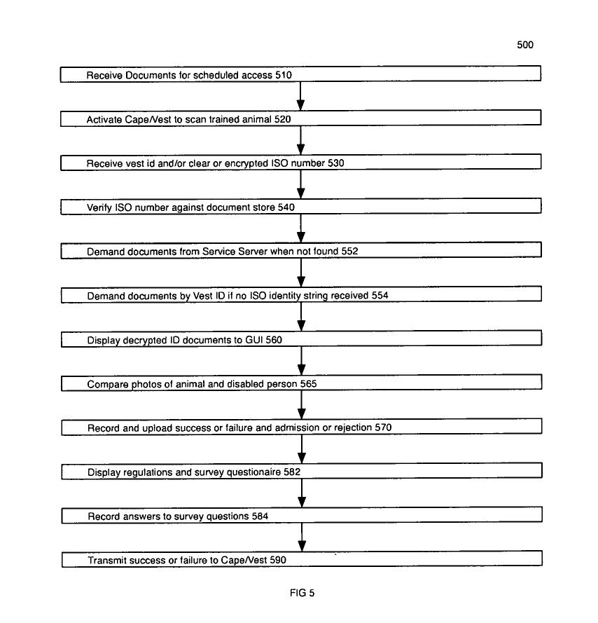

FIG. 5 is a method/process flow chart 500 of methods and processes performed by a processor at a communication device 400.

In an embodiment, the method comprising the steps at a communication device following: receiving Documents for scheduled access 510; activating Cape/Vest to scan trained animal 520; receiving vest id and clear or encrypted identity (e.g. ISO) number 530; verifying identity e.g. ISO number against document store 540; demanding documents from Service Server when not found 552; demanding documents by Vest ID if no ISO received 554; displaying decrypted ID documents to GUI 560; comparing photos of animal and disabled person 565; recording and uploading success or failure and admission or rejection 570; displaying regulations and survey questionnaire 582; recording answers to survey questions 584; and transmitting success or failure to Cape/Vest 590.

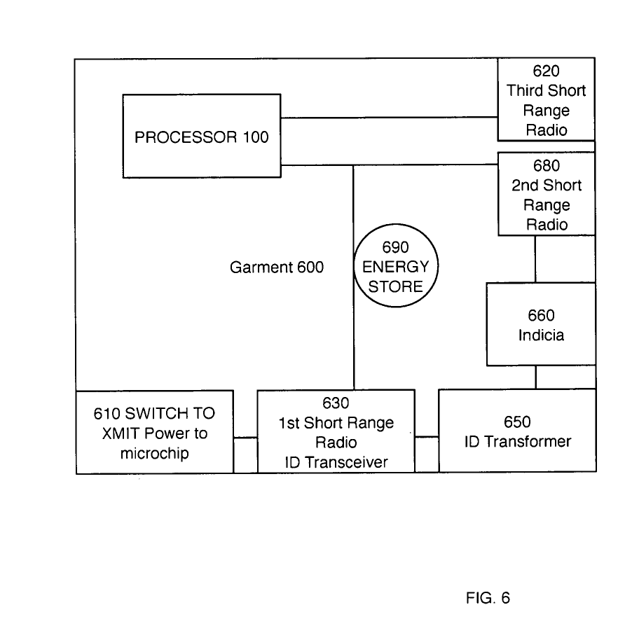

FIG. 6 is a block diagram of electronic components of a garment to be worn on a trained assistance animal which has been injected with a microchip for identification.

Referring now to FIG. 6, a garment 600 has interconnected active components which comprises: a processor 100, a switch 610 to enable a microchip to accumulate electrical energy in a resonant circuit, a short range radio receiver 630 to receive an electromagnetic signal encoded with an identification string, and a circuit 650 to transform the identification string in combination with a serial number associated with the garment; and all of said active components coupled to an electrical energy store device 690. In an embodiment, the garment further comprises an indicia device 660 to display a transformed identification string such as in a QR code or to display success or failure in identification. In an embodiment, the garment further comprises a second short range radio 680 to transmit the transformed identification string to a communication device such as by Bluetooth or NFC transmission. In an embodiment, the garment further comprises a third short range radio 620 to receive commands from a communication device.

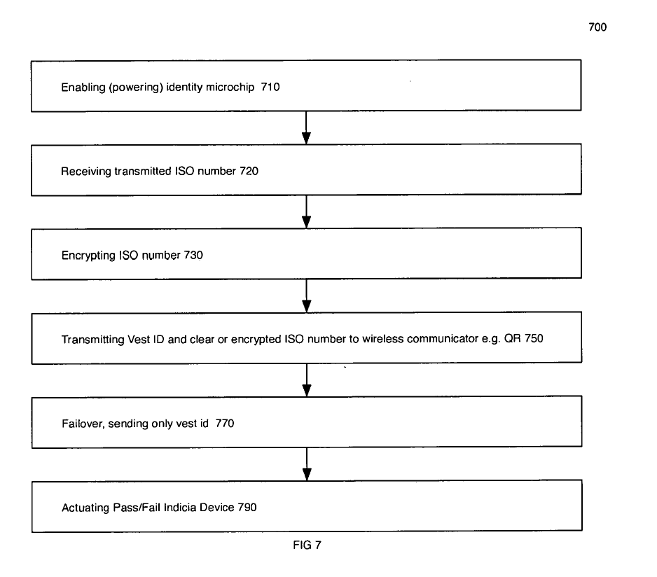

FIG. 7 is a method/process flow chart of methods and processes 700 performed by a processor at a garment 600.

In an embodiment, the method comprising the steps at a garment: enabling (powering) identity microchip 710; receiving transmitted ISO number 720; encrypting identity (e.g. ISO) number 730; transmitting Vest ID and clear or encrypted ISO number to wireless communicator e.g. QR 750; failover, sending only vest id 770; and in an embodiment, actuating Pass/Fail Indicia Device 790.

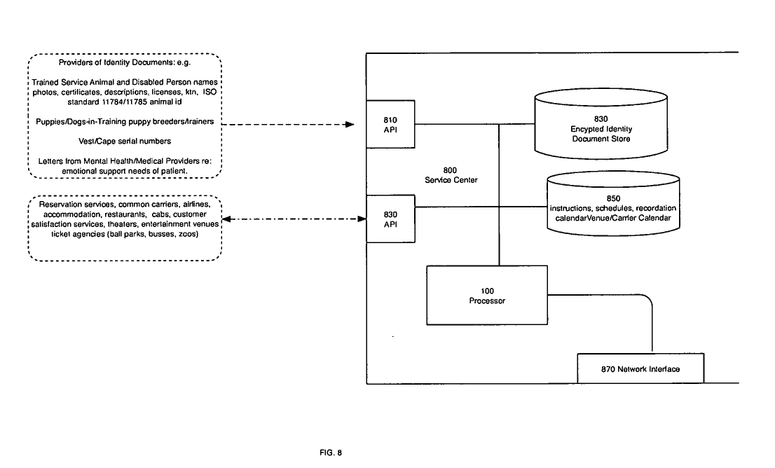

FIG. 8 is a block diagram of a service center 800.

Referring now to FIG. 8, a service center 800 comprises at least one processor 100 communicatively coupled to a first non-transitory computer readable store 830 for encrypted identity documents; a second non-transitory computer readable store 850 for instructions, schedules and recordation of access, including a calendar of reservations; and a network interface 870 to at least one communication device. In an embodiment, the service center further comprises a first application programming interface (API) 810 accessible by providers of identity documents to store identity documents for trained assistance animals. In an embodiment, the service center further comprises a second application programming interface (API) 830 accessible by reservation services to inquire on the authenticity of animals as trained in assistance and to courteously pre-seat them into transportation, accommodation, or admission.

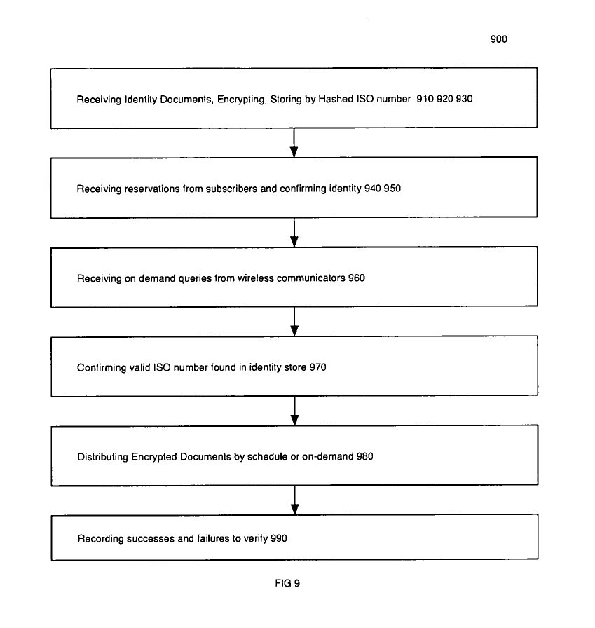

FIG. 9 is a method/process flow chart of methods and processes performed by a processor at a service center 800. In an embodiment, the method comprising the steps at a service center following: receiving Identity Documents, Encrypting, Storing by Hashed ISO number 910 930; receiving reservations from subscribers and confirming identity 940 950; receiving on demand queries from wireless communicators 960; confirming valid ISO number found in identity store 970; distributing Encrypted Documents by schedule or on-demand 980; and recording successes and failures to verify 990.

### Conclusion

The present invention may be easily distinguished by the pre-distribution of identity documentation to the venue or location of an expected trained assistance animal according to a reservation system. The present invention may be easily distinguished from conventional microchip readers by transformation and decrypting the identity documentation files by linking an active garment to a communication device. The present invention is easily distinguished from hand held microchip readers which lack storage for identity documents and communication capability to receive them.

The techniques described herein can be implemented in digital electronic circuitry, or in computer hardware, firmware, software, or in combinations of them. The techniques can be implemented as a computer program product, i.e., a computer program tangibly embodied in a non-transitory information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; internal hard disks or removable disks. The processor and the memory can be supplemented by, or incorporated in special purpose logic circuitry.

In an embodiment, of the invention, the method of the garment/vest/cape receiving an animal identification string from a microchip previously injected into a service animal; transforming the animal identification string into a format for transmission to a communication device, in an embodiment a QR code on a display; which the wireless communication device receives , in an embodiment one of scanning using a camera and receiving an electromagnetic signal; and at a wireless communication device, comparing the transformed animal identification string to the documentation distributed from the service center.

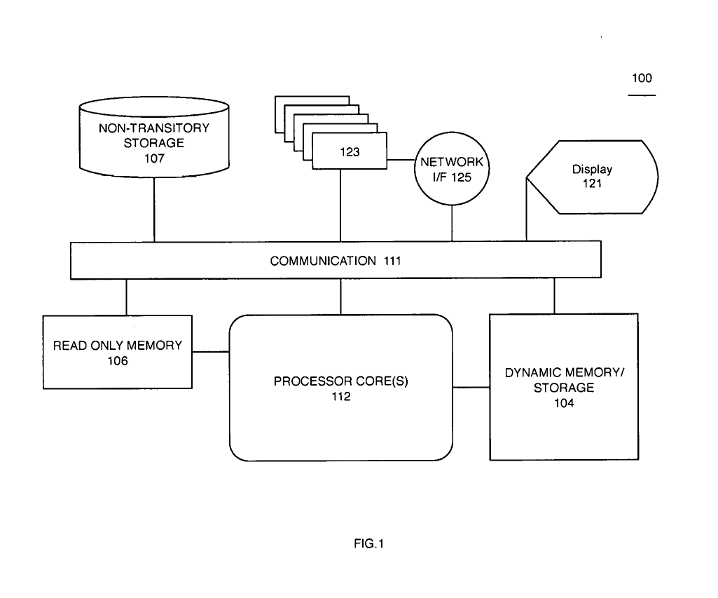

Referring in detail to FIG. 1, FIG. 1 is a block diagram of an exemplary processor that may be used to perform one or more of the functions described herein. Referring to FIG. 1, processor 100 may comprise an exemplary client or server process. Processor 100 comprises a communication mechanism or bus 111 for communicating information, and a processor core 112 coupled with bus 111 for processing information. Processor core 112 comprises at least one processor core, but is not limited to a processor core, such as for example, ARM™, Pentium™, etc. Processor 100 further comprises a random-access memory (RAM), or other dynamic storage device 104 (referred to as main memory) coupled to bus 111 for storing information and instructions to be executed by processor 112. Main memory 104 also may be used for storing temporary variables or other intermediate information during execution of instructions by processor core 112.

Processor 100 also comprises a read only memory (ROM) and/or other static storage device 106 coupled to bus 111 for storing static information and instructions for processor core 112, and a non-transitory data storage device 107, such as a magnetic storage device or flash memory and its associated control circuits. Data storage device 107 is coupled to bus 111 for storing information and instructions. Processor 100 may further be coupled to a display device 121 such a flat panel display, coupled to bus 111 for displaying information to a computer user. Voice recognition, optical sensor, motion sensor, microphone, keyboard, touch screen input, and pointing devices 123 may be attached to bus 111 or a network interface (wired or wireless) 125 for communicating selections and command and data input to processor core 112.

It is understood that the processor may be embedded within other circuits of the system as an embodiment of an ARM core or equivalent or as a virtual machine within a multi-core server.

A number of mere embodiments of the invention have been described. Nevertheless, it will be understood that various modifications may be made without departing from the spirit and scope of the invention. Accordingly, other embodiments are within the scope of the following claims.

We claim:

1. A method of operation causing a wireless mobile communication device to perform the processes:
receiving a plurality of protected ID files (portfolio) containing identity documentation of registered trained assistance animals expected within a period of time at a portal;
initiating a verification process by an activated controlled garment (idcape) that is worn by a microchipped trained assistance animal;
receiving at least one of an encrypted identity string and a garment serial number from said idcape (refhash);
comparing said refhash with said portfolio;
upon failing to match said refhash with a member of the portfolio, initiating a request for identity documentation (RID) process with a service center database and displaying a result of the RID;
upon determining a successful refhash match with a member of the portfolio, opening one of the ID files and displaying the identity documentation (images, names, descriptions, trained behaviors, audio); and
presenting an interactive display to confirm and record the successful verification of the trained assistance animal at a time and place.

2. A trained assistance animal verification system comprising:
an activated controlled garment (idcape); the idcape communicatively coupled to,
a wireless mobile communication device; said device communicatively coupled to, and
a trained assistance animal identity service center host.

3. The system of claim 2 further comprising: at least one
identity microchip injected into a trained assistance animal by a training provider; and
an interface to at least one public accommodation reservation application server.

4. A wireless communication device comprises:
a transceiver communicatively coupled to exchange indices and identification documents with a trained assistance animal identity service host;
a circuit to enable a controlled garment to cause an identification device embedded within a trained assistance animal to present it unique identity code;
a circuit to receive and transform a unique identity code from the identification device; and
a circuit to compare and subsequently annunciate the result of the comparison of unique identity codes received from a host and from a garment.

5. The device of claim 4 further comprising:
a store for identity documents downloaded from a service center of trained assistance animals scheduled for admittance at a venue.

6. The device of claim 4 further comprising:
a graphical display suitable for a photographic image of the trained assistance animal and its accompaniant.

7. The device of claim 4 further comprising:
a circuit to enable the controlled garment to annunciate a successful comparison.

8. An activated controlled garment comprises:
an energizing element for an injected identity microchip;
a short-range radio receiver for identity code;
an encoder to transform said identity code;
a transceiver to exchange data with a wireless communication device, and
an indicator circuit capable of emitting indicia of success or failure in validation.

9. A service center host comprises:
a trained assistance animal registration server accessible to trainers;
a calendar server accessible to venue managers;
a calendar server accessible to trained assistance animal handlers;
a cross-reference mapping between venues and trained assistance animal identities;
a computer-readable non-transitory store of trained assistance animal documents; and
an interface to communication devices operable to read trained assistance animal garments and report success or failure on verifying a document.

10. A method comprising the processes:
comparing hash of eligible animals in database with hash received from vest;
at a vest, enabling a microchip to emit a registration code;
receiving a registration code from a microchip 102;
transforming said registration code to a hashed code;
requesting verification of code from server by cellular network transceiver;
establishing secure upload with a communication device;
verifying code with server provided documentation;
at a communication device, determining that record of animal is one of found or not found;
at a server, determining that record of animal is one of found or not found;
upon the condition not found, activating indicia circuit to signal failure;
upon the condition found, activating indicia circuit to signal the condition of trained assistance animal verified.

11. A method of operating an activated controlled garment comprising the processes:
receiving an initiation signal to energize at least one wireless transceiver;
enabling an identification device embedded within a trained assistance animal to present its unique identity code;
receiving said unique identity code associated with the trained assistance animal; and
transforming said unique identity code for presentation to a wireless communication device.

12. The method of claim 11 further comprising:
receiving indicia of acceptance of the unique identity code by the wireless communication device; and
enabling feedback of the successful identification by actuators and a tangible interface device.

13. A method of operating a trained assistance animal identity service center comprising the processes:
receiving from a training entity identification documents for a trained assistance animal;
registering a trained assistance animal into a known trained assistance animal store;
receiving an encrypted index from a wireless communication device;
retrieving identification documents by the encrypted index; and
confirming the registration of the trained assistance animal by transmitting to the wireless communication device at least one identification document.

14. The method of claim 13 further comprising:
receiving from a reservation system a scheduled admittance for a trained assistance animal at a venue;
verifying the registration of the trained assistance animal in an identifier data store; and distributing to a wireless communication device identification documents of at least one trained assistance animal scheduled for admittance at the venue.

15. The method of claim 14 further comprising:
operating an actuator to enable a portal, and
triggering an image capture device of any animal transiting the portal.

16. A wireless communication device comprises:
a transceiver communicatively coupled to exchange indices and identification documents with a trained assistance animal identity service host;
a circuit to cause an identification device embedded within a trained assistance animal to present it unique identity code;
an energizing element for an injected identity microchip;
a short-range radio receiver for receiving an identity code;
a circuit to transform a unique identity code from the identification device;
a circuit to compare and subsequently annunciate the result of the comparison of unique identity codes received from a host and from a garment;
a store for identity documents downloaded from a service center of trained assistance animals scheduled for admittance at a venue; and
a graphical display suitable for a photographic image of the trained assistance animal and its accompaniant.
